(19) United States
(12) Patent Application Publication
(10) Pub. No.: US 2017/0249046 A1
(43) Pub. Date: Aug. 31, 2017

(54) LIQUID CRYSTAL DISPLAY DEVICE, WIRING SUBSTRATE, AND SENSOR-EQUIPPED DISPLAY DEVICE

(71) Applicant: Japan Display Inc., Minato-ku (JP)

(72) Inventor: Jin HIROSAWA, Tokyo (JP)

(73) Assignee: Japan Display Inc., Minato-ku (JP)

(21) Appl. No.: 15/442,149

(22) Filed: Feb. 24, 2017

(30) Foreign Application Priority Data
Feb. 25, 2016 (JP) 2016-033979

(51) Int. Cl. G06F 3/041; G02F 1/1337; G02F 1/1343; G06F 3/044; G02F 1/1333

(52) U.S. Cl. CPC G06F 3/0416; G06F 3/044; G02F 1/133345; G02F 1/134336; G02F 1/1337; G02F 1/13439; G06F 2203/04111; G02F 2201/123; G02F 2201/121; G02F 2202/02; G02F 2001/133742

(57) ABSTRACT

According to one embodiment, a liquid crystal display device includes a first substrate includes an insulating substrate, an organic insulating film including a first upper surface and a second upper surface, a step being created by a height difference between the first upper surface and the second upper surface, a common electrode located on the first upper surface, a pixel electrode located on the second upper surface, and a first alignment film which covers the common electrode and the pixel electrode, a second substrate includes a second alignment film opposed to the first alignment film, and a liquid crystal layer held between the first alignment film and the second alignment film.

### CROSS-REFERENCE TO RELATED APPLICATIONS

This application is based upon and claims the benefit of priority from Japanese Patent Application No. 2016-033979, filed Feb. 25, 2016, the entire contents of which are incorporated herein by reference.

### FIELD

Embodiments described herein relate generally to a liquid crystal display device, a wiring substrate, and a sensor-equipped display device.

### BACKGROUND

Recently, liquid crystal display devices having structures adaptive to various display modes have been put into practical use. For example, in a display mode which mainly uses a longitudinal electric field that is substantially perpendicular to the main surface of a substrate, a structure in which a pixel electrode is provided on one substrate of the two substrates which constitute the liquid crystal display device, and a common electrode is provided on the other substrate is applicable.

Meanwhile, sensors capable of detecting contact or approach of an object to be detected such as a finger have been put into practical use as a display device interface or the like. A capacitive touch panel, which is an example of the sensors, comprises an electrode for detecting a change in the electrostatic capacitance caused by the object. When a sensor is mounted on a display device, deterioration in display quality is required to be suppressed as the display device while ensuring sensitivity as the sensor.

### BRIEF DESCRIPTION OF THE DRAWINGS

FIG. 1 is an illustration showing the structure of a display device DSP according to the present embodiment.

FIG. 2 is an illustration showing a basic structure and an equivalent circuit of the display panel PNL shown in FIG. 1.

FIG. 3 is a plan view showing a configuration example of a pixel PX when a first substrate SUB1 shown in FIG. 1 is viewed from a second substrate.

FIG. 4 is a cross-sectional view showing the structure of a part of the display panel PNL taken along line A-B of FIG. 3.

FIG. 5 is a cross-sectional view showing the structure of a part of the display panel PNL taken along line C-D of FIG. 3.

FIG. 6 is a perspective view showing a configuration example of the first substrate SUB1 illustrated in FIG. 3.

FIG. 7 is an illustration showing a configuration example of a sensor SS.

FIG. 8 is an illustration for explaining the principle of a method of sensing by the sensor SS applicable to the present embodiment.

FIG. 9 is a plan view showing a configuration example of a capacitance electrode C included in a sensor driving electrode Tx shown in FIG. 7.

FIG. 10 is a plan view showing another configuration example of the capacitance electrode C included in the sensor driving electrode Tx shown in FIG. 7.

FIG. 11 is a plan view showing yet another configuration example of the capacitance electrode C included in the sensor driving electrode Tx shown in FIG. 7.

FIG. 12 is a plan view showing another configuration example of the pixel PX when the first substrate SUB1 shown in FIG. 1 is viewed from the second substrate.

FIG. 13 is a plan view showing yet another configuration example of the pixel PX when the first substrate SUB1 shown in FIG. 1 is viewed from the second substrate.

FIG. 14 is a perspective view showing a configuration example of the first substrate SUB1 illustrated in FIG. 3.

FIG. 15 is a cross-sectional view showing another configuration example of the display panel PNL taken along line A-B of FIG. 3.

FIG. 16 is a plan view showing yet another configuration example of the pixel PX when the first substrate SUB1 shown in FIG. 1 is viewed from the second substrate.

FIG. 17 is an illustration showing another configuration example of the sensor SS.

FIG. 18 is a cross-sectional view of a contact portion taken along line E-F of FIG. 17.

### DETAILED DESCRIPTION

In general, according to one embodiment, a liquid crystal display device includes: a first substrate comprising an insulating substrate, an organic insulating film including a first upper surface and a second upper surface, a step being created by a height difference between the first upper surface and the second upper surface, a common electrode located on the first upper surface, a pixel electrode located on the second upper surface, and a first alignment film which covers the common electrode and the pixel electrode; a second substrate comprising a second alignment film opposed to the first alignment film; and a liquid crystal layer held between the first alignment film and the second alignment film.

According to another embodiment, a wiring substrate includes: a first interlayer insulating film; a scanning line, a first capacitance electrode, and a second capacitance electrode, which are located on the first interlayer insulating film and are separated from each other; a second interlayer insulating film which covers the scanning line, the first capacitance electrode, and the second capacitance electrode; a bridge portion which is located on the second interlayer insulating film, electrically connects the first capacitance electrode and the second capacitance electrode to each other, and crosses the scanning line; and a signal line which is located on the second interlayer insulating film, is separated from the bridge portion, and crosses the scanning line.

According to yet another embodiment, a sensor-equipped display device includes: a first substrate comprising a sensor driving electrode;

a second substrate comprising a detection electrode; and a liquid crystal layer held between the first substrate and the second substrate, the first substrate comprising: a first interlayer insulating film; a scanning line, a first capacitance electrode, and a second capacitance electrode, which are located on the first interlayer insulating film and are separated from each other; a second interlayer insulating film which covers the scanning line, the first capacitance electrode, and the second capacitance electrode; and a bridge portion which is located on the second interlayer insulating film, electrically connects the first capacitance electrode and the second capacitance electrode to each other, and crosses the scanning line, the sensor driving electrode comprising the first capacitance electrode, the second capacitance electrode, and the bridge portion.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the structural elements, which have functions identical or similar to the functions described in connection with preceding drawings, are denoted by the same reference numbers, and an overlapping detailed description thereof may be arbitrarily omitted.

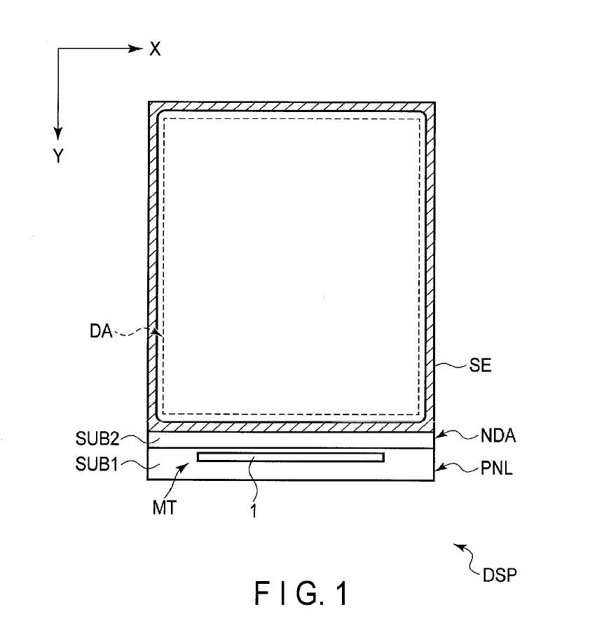

FIG. 1 is a view showing the structure of a display device DSP of the present embodiment. The figure shows a plan view of the display device DSP in an X-Y plane defined by a first direction X and a second direction Y which intersect each other. In the present embodiment, a liquid crystal display device is explained as an example of the display device. Note that the main structures disclosed in the present embodiment are applicable to various display devices such as a self-luminous display device with organic electroluminescent display elements and the like, an electronic paper display device with cataphoretic elements and the like, a display device employing micro-electromechanical systems (MEMS), and a display device employing electrochromism.

The display device DSP includes a display panel PNL, a driving IC chip 1 which drives the display panel PNL, etc. The display panel PNL is, for example, a liquid crystal display panel, and includes a first substrate SUB1, a second substrate SUB2, a seal portion SE, and a liquid crystal layer (a liquid crystal layer LC which will be described later). The second substrate SUB2 is opposed to the first substrate SUB1. The seal portion SE bonds the first substrate SUB1 and the second substrate SUB2 together. The display panel PNL includes a display area DA in which an image is displayed, and a frame-like non-display area NDA which surrounds the display area DA. The display area DA is located at an inner side surrounded by the seal portion SE.

The driving IC chip 1 is located in the non-display area NDA. In the example illustrated, the driving IC chip 1 is mounted on a mounting portion MT of the first substrate SUB1 which extends to the outer side of the second substrate SUB2. In the driving IC chip 1, a display driver which outputs a signal necessary for displaying an image, for example, is incorporated. The display driver described in this specification includes at least a part of a signal line drive circuit SD, a scanning line drive circuit GD, and a common electrode drive circuit CD, which will be described later. Note that the driving IC chip 1 may be mounted on a flexible substrate connected to the display panel PNL separately, not limited to the illustrated example.

The display panel PNL of the present embodiment may be a transmissive display panel having a transmissive display function of displaying an image by selectively passing light from a rear surface of the first substrate SUB1, a reflective display panel having a reflective display function of displaying an image by selectively reflecting light from a front surface of the second substrate SUB2, or a transflective display panel including both the transmissive display function and the reflective display function.

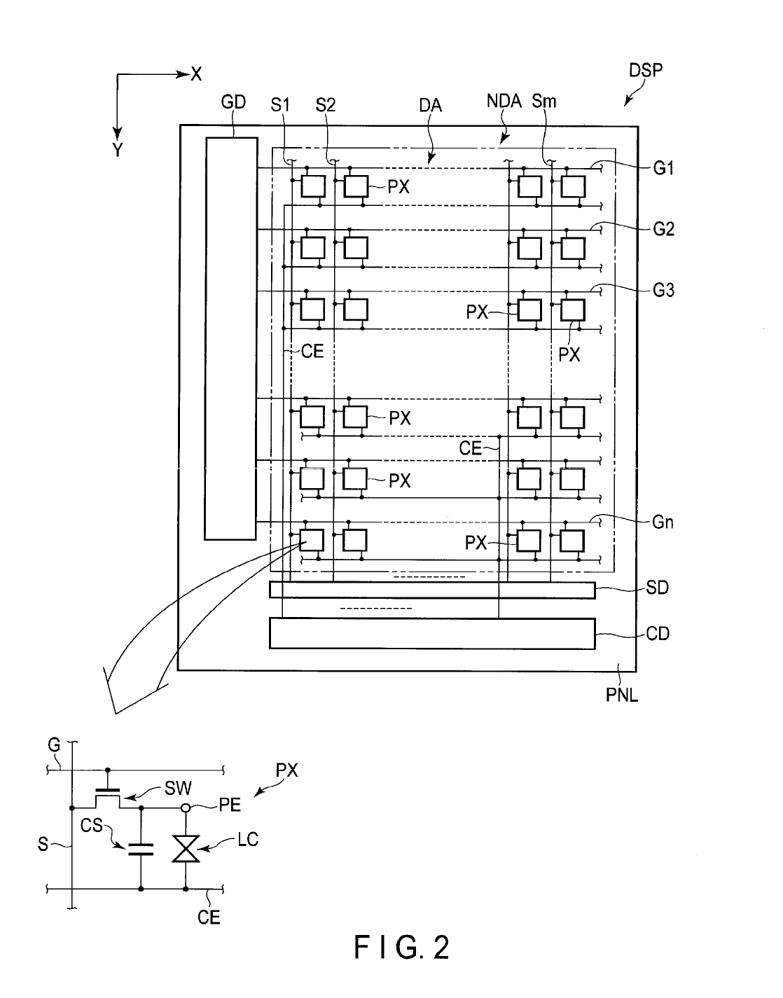

FIG. 2 is an illustration showing a basic structure and an equivalent circuit of the display panel PNL shown in FIG. 1.

The display panel PNL includes a plurality of pixels PX in the display area DA. The pixels PX are arrayed in a matrix in the first direction X and the second direction Y. Also, the display panel PNL includes scanning lines G (G1 to Gn), signal lines S (S1 to Sm), a common electrode CE, etc., in the display area DA. The scanning lines G extend in the first direction X, and are arranged in the second direction Y. The signal lines S extend in the second direction Y, and are arranged in the first direction X. Note that the scanning lines G and the signal lines S do not necessarily extend linearly, and may be partially bent. The common electrode CE is disposed over the pixels PX.

The scanning lines G are connected to the scanning line drive circuit GD. The signal lines S are connected to the signal line drive circuit SD. The common electrode CE is connected to the common electrode drive circuit CD. The signal line drive circuit SD, the scanning line drive circuit GD, and the common electrode drive circuit CD may be formed on the first substrate SUB1 in the non-display area NDA, or some of these circuits or all of these circuits may be incorporated in the driving IC chip 1 illustrated in FIG. 1. Also, the layout of the drive circuits is not limited to the example illustrated. That is, for example, the scanning line drive circuit GD may be disposed on each of the two sides of the display area DA to sandwich the display area DA.

Each of the pixels PX comprises a switching element SW, a pixel electrode PE, the common electrode CE, the liquid crystal layer LC, and the like. The switching element SW is constituted by a thin-film transistor (TFT), for example, and is electrically connected to the scanning line G and the signal line S. The scanning line G is connected to the switching elements SW of the respective pixels PX arranged in the first direction X. The signal line S is connected to the switching elements SW of the respective pixels PX arranged in the second direction Y. The pixel electrode PE is electrically connected to the switching element SW. Each pixel electrode PE is opposed to the common electrode CE, and drives the liquid crystal layer LC by an electric field produced between the pixel electrode PE and the common electrode CE. A storage capacitance CS is formed between, for example, an electrode having the same potential as the common electrode CE and an electrode having the same potential as the pixel electrode PE.

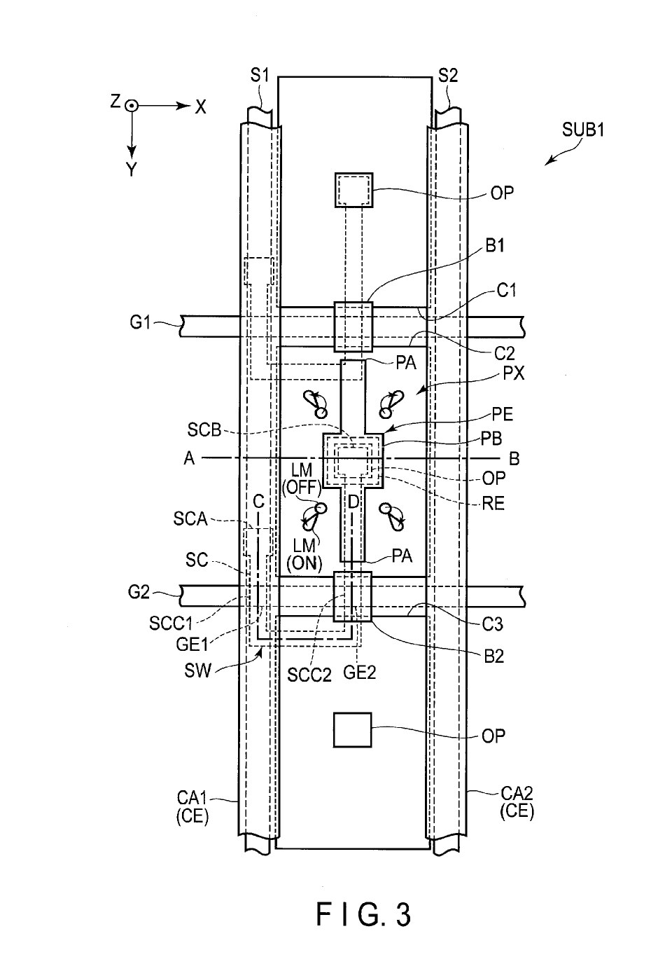

FIG. 3 is a plan view showing a configuration example of the pixel PX when the first substrate SUB1 shown in FIG. 1 is viewed from the second substrate side. The figure shows the plan view in the X-Y plane. A third direction Z in FIG. 3 is the direction which intersects the first direction X and the second direction Y.

The first substrate SUB1 includes scanning lines G1 and G2, signal lines S1 and S2, capacitance electrodes C1 to C3, bridge portions B1 and B2, the switching element SW, the pixel electrode PE, the common electrode CE, etc.

The scanning lines G1 and G2 are disposed at an interval in the second direction Y, and each of the scanning lines G1 and G2 extends in the first direction X. The signal lines S1 and S2 are disposed at an interval in the first direction X, and each of the signal lines S1 and S2 extends in the second direction Y. In the example illustrated, the pixel PX corresponds to a box-shaped area which is defined by the scanning lines G1 and G2 and the signal lines S1 and S2, and is rectangular in shape having a length along the first direction X shorter than a length along the second direction Y. The length of the pixel PX along the first direction X corresponds to a pitch along the first direction X between the signal lines S1 S2. The length of the pixel PX along the second direction Y corresponds to a pitch along the second direction Y between the scanning lines G1 and G2.

Each of the capacitance electrodes C1 to C3 is formed in an island shape, and the capacitance electrodes C1 to C3 are arranged to be spaced apart from each other in the second direction Y. In the example illustrated, each of the capacitance electrodes C1 to C3 is formed in a rectangular shape having a length along the first direction X shorter than a length along the second direction Y. Also, each of the capacitance electrodes C1 to C3 includes an opening OP at substantially the central portion. With respect to the capacitance electrodes C1 to C3, the length along the first direction X is substantially equal to an interval between the signal lines S1 and S2 in one example, and the length along the second direction Y is shorter than an interval between the scanning lines G1 and G2. These capacitance electrodes C1 to C3 are disposed in the same layer as the scanning lines G1 and G2, though this will be described later, and are separated from the scanning lines G1 and G2. In the example illustrated, the capacitance electrode C1, the scanning line G1, the capacitance electrode C2, the scanning line G2, and the capacitance electrode C3 are arranged in the second direction Y in this order.

Each of the bridge portions B1 and B2 is formed in an island shape, and the bridge portions B1 and B2 are arranged to be spaced apart from each other in the second direction Y. The bridge portion B1 is electrically connected to each of the capacitance electrodes C1 and C2, and crosses the scanning line G1. The bridge portion B2 is electrically connected to each of the capacitance electrodes C2 and C3, and crosses the scanning line G2. According to such a structure, the capacitance electrodes C1 to C3 are electrically connected to each other via the bridge portions B1 and B2, and all of the capacitance electrodes C1 to C3 are supplied with the same voltage (or the same signal). In one example, the capacitance electrodes C1 to C3 have the same potential as the common electrode CE, and are electrically connected to the common electrode drive circuit CD in the non-display area NDA.

The switching element SW is electrically connected to the scanning line G2 and the signal line S1. The switching element SW of the illustrated example has a double-gate structure. The switching element SW comprises a semiconductor layer SC and a relay electrode RE. The semiconductor layer SC is disposed to overlap the signal line S1, is partly extended between the signal line S1 and the signal line S2, and is formed to be substantially U-shaped. The semiconductor layer SC includes a channel region SCC1 which crosses the scanning line G2 in an area overlapping the signal line S1, and a channel region SCC2 which crosses the scanning line G2 in an area between the signal line S1 and the signal line S2. In the scanning line G2, areas which overlap the channel regions SCC1 and SCC2 serve as gate electrodes GE1 and GE2, respectively. The semiconductor layer SC is electrically connected to the signal line S1 at an end portion SCA of the semiconductor layer SC, and is electrically connected to the relay electrode RE at the other end portion SCB of the same. The relay electrode RE is formed in an island shape, is disposed between the scanning lines G1 and G2 and between the signal lines S1 and S2, and overlaps the other end portion SCB through the opening OP of the capacitance electrode C2.

When the positional relationship among the capacitance electrodes C2 and C3, and the semiconductor layer SC is focused, in the semiconductor layer SC, a region between the channel regions SCC1 and SCC2 overlaps the capacitance electrode C3, and a region between the channel region SCC2 and the other end portion SCB overlaps the capacitance electrode C2. The channel region SCC2 and the gate electrode GE2 overlap the bridge portion B2. According to such a structure, the storage capacitance CS shown in FIG. 2 can be produced between the capacitance electrode C2 or C3, and the semiconductor layer SC.

The pixel electrode PE is disposed between the scanning lines G1 and G2, and between the signal lines S1 and S2. The pixel electrode PE comprises a main electrode portion PA and a contact portion PB. The main electrode portion PA and the contact portion PB are formed integral or continuous, and are electrically connected to each other. The pixel electrode PE illustrated is formed in substantially a cross shape.

The main electrode portion PA is located in substantially the middle of the signal lines S1 and S2, and linearly extends in the second direction Y from the contact portion PB to the vicinity of an upper side end portion of the pixel PX (that is, near the scanning line G1), and to the vicinity of a lower side end portion of the pixel PX (that is, near the scanning line G2). The main electrode portion PA is formed in a strip shape having a substantially uniform width in the first direction X. The contact portion PB is located at the central portion of the pixel PX, and is more broadened in the first direction X than the main electrode portion PA. The contact portion PB is disposed at a position which overlaps the relay electrode RE, and is electrically connected to the relay electrode RE. The pixel electrode PE is thereby electrically connected to the switching element SW.

The common electrode CE comprises main common electrodes CA1 and CA2. The main common electrodes CA1 and CA2 are separated from the pixel electrode PE. Each of the main common electrodes CA1 and CA2 extends linearly in the second direction Y, and is formed in a strip shape having a substantially uniform width in the first direction X. In the example illustrated, the main common electrode CA1 overlaps the signal line S1, and the main common electrode CA2 overlaps the signal line S2.

In the present embodiment, in the pixel PX, a region between the pixel electrode PE and the common electrode CE corresponds to a region which contributes to display. In the example illustrated, the capacitance electrode C2 extends over the region between the pixel electrode PE and the common electrode CE, and overlaps the pixel electrode PE. Further, end portions of the capacitance electrode C2 close to the signal lines S1 and S2, respectively, overlap the common electrode CE. The capacitance electrode C2 functions as a reflective layer in a reflective display panel. Note that the relay electrode RE may be more broadened than in the illustrated example, and have the broadened relay electrode RE function as a reflective layer. However, as described later, since the relay electrode RE is disposed in the same layer as the signal lines S1 and S2, the relay electrode RE can be broadened in the range of not contacting the signal lines S1 and S2. Also, as described later, by more reducing the width of the capacitance electrode than in the illustrated example, in the transmissive or transflective display panel, a transmissive region can be formed between the pixel electrode PE and the common electrode CE.

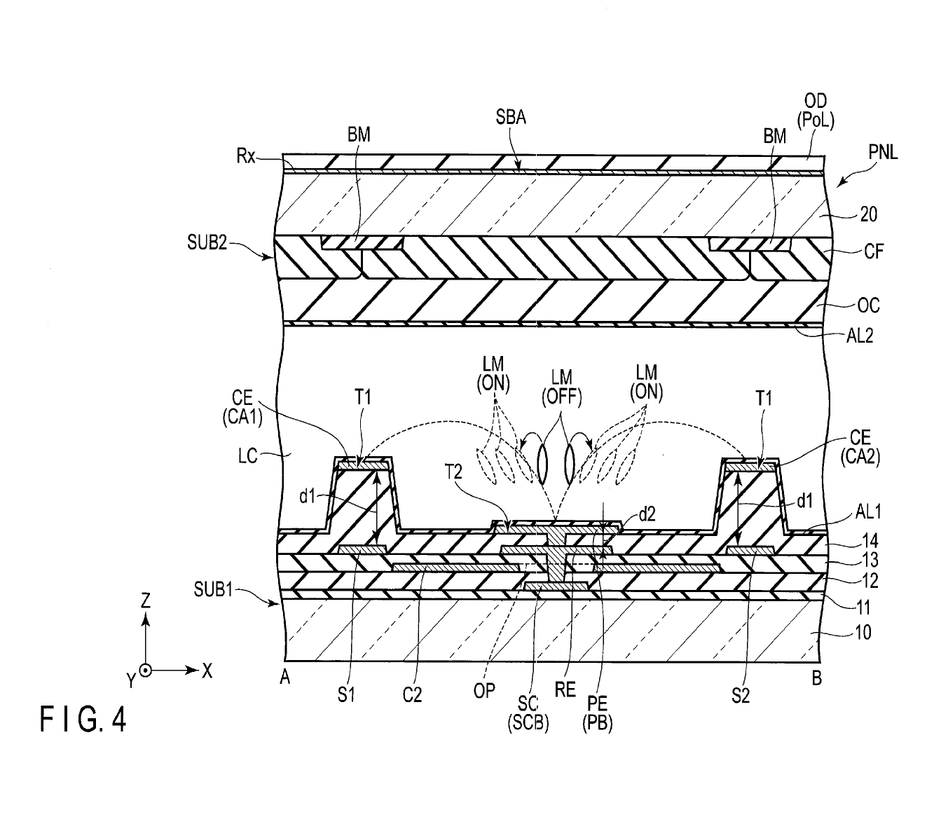

FIG. 4 is a cross-sectional view showing the structure of a part of the display panel PNL taken along line A-B of FIG. 3. In the present specification, a direction toward a pointing end of an arrow indicating the third direction Z is referred to as upward (or merely above), and a direction toward the opposite side from the pointing end of the arrow is referred to as downward (or merely below). Further, it is assumed that an observation position at which the display device DSP is to be observed is at the pointing end side of the arrow indicating the third direction Z, and a view toward the X-Y plane from the observation position is called a planar view.

The first substrate SUB1 includes a first insulating substrate 10, a first insulating film 11, a second insulating film 12, a third insulating film 13, a fourth insulating film 14, the semiconductor layer SC, the capacitance electrode C2, the signal lines S1 and S2, the relay electrode RE, the common electrode CE, the pixel electrode PE, a first alignment film AL1, and the like.

The first insulating substrate 10 is a light transmissive substrate such as a glass substrate or a resin substrate. The first insulating film 11 is located on the first insulating substrate 10. The semiconductor layer SC is located on the first insulating film 11 and is covered with the second insulating film 12. The semiconductor layer SC is formed of, for example, polycrystalline silicon, but may be formed of amorphous silicon or an oxide semiconductor. The capacitance electrode C2 is located on the second insulating film 12 and is covered with the third insulating film 13. Note that the capacitance electrodes C1 and C3 and the scanning lines G1 and G2, which are not illustrated, are also disposed in the same layer as the capacitance electrode C2. The capacitance electrode C2 is formed of a metal material such as aluminum (Al), titanium (Ti), silver (Ag), molybdenum (Mo), tungsten (W), copper (Cu) or chromium (Cr), or an alloy obtained by combining the aforementioned metal materials. The capacitance electrode C2 may have a single-layer structure or a multilayer structure. When a function as the reflective layer is required for the capacitance electrode C2, preferably, the capacitance electrode C2 should include a reflective member formed of a highly reflective material such as aluminum on its upper surface.

The signal lines S1 and S2, the relay electrode RE, and the bride portion are located on the third insulating film 13, and are covered with the fourth insulating film 14. The signal lines S1 and S2 and the relay electrode RE are formed of the same material, and the above-mentioned metal material can be applied. Note that the bridge portion is also formed of the same material as that of the signal line and the relay electrode.

The common electrode CE and the pixel electrode PE are disposed on the fourth insulating film 14, and are covered with the first alignment film AL1. The common electrode CE and the pixel electrode PE are formed of the same material, and the above-mentioned metal material can be applied. Also, the capacitance electrode C, the common electrode CE, and the pixel electrode PE are formed of a transparent conductive material such as indium-tin-oxide (ITO) or indium-zinc-oxide (IZO). The pixel electrode PE is in contact with the relay electrode RE through a contact hole which penetrates the fourth insulating film 14 at a position which overlaps the opening OP.

Each of the first insulating film 11, the second insulating film 12, and the third insulating film 13 is an inorganic insulating film such as silicon oxide, silicon nitride, or silicon oxynitride, and may have a single-layer structure or a multilayer structure. The fourth insulating film 14 is an organic insulating film such as acrylic resin.

The fourth insulating film 14 includes a first upper surface T1 and a second upper surface T2 on the side opposed to the second substrate SUB2, and a step is created by a height difference between the first upper surface T1 and the second upper surface T2. More specifically, the first upper surface T1 is located closer to the second substrate SUB2 than the second upper surface T2 is. Each of the first upper surface T1 and the second upper surface T2 is substantially flat, and is substantially parallel to the X-Y plane. The first upper surface T1 is located directly above the signal lines S1 and S2. The common electrodes CE (the main common electrodes CA1 and CA2) are located on the first upper surface T1. That is, the fourth insulating film 14 is disposed between the signal line S1 and the main common electrode CA1, and between the signal line S2 and the main common electrode CA2. The second upper surface T2 is located directly above the capacitance electrode C2 and the relay electrode RE. The pixel electrode PE is located on the second upper surface T2. That is, the fourth insulating film 14 is disposed between the relay electrode RE and the pixel electrode PE. Further, in the second upper surface T2, a region which does not overlap the pixel electrode PE is covered with the first alignment film AL1. As has been illustrated, the common electrode CE is located closer to the second substrate SUB2 than the pixel electrode PE is.

As regards the film thickness of the fourth insulating film 14, the fourth insulating film 14 has a first film thickness d1 between the signal line and the common electrode, more specifically, each of the signal lines S1 and S2 and the common electrodes CE (the main common electrodes CA1 and CA2), and has a second film thickness d2 between the relay electrode RE and the pixel electrode PE. The first film thickness d1 is different from the second film thickness d2, and in the example illustrated, the first film thickness d1 is greater than the second film thickness d2. Accordingly, the common electrode CE is closer to the second substrate SUB2 than the pixel electrode PE is.

The second substrate SUB2 comprises a second insulating substrate 20, a light-shielding layer BM, a color filter CF, an overcoat layer OC, a second alignment film AL2, etc.

The second insulating substrate 20 is a light transmissive substrate such as a glass substrate or a resin substrate. The light-shielding layer BM and the color filter CF are located on the second insulating substrate 20 at the side opposed to the first substrate SUB1. The light-shielding layer BM is arranged at positions which delimit the pixels and are opposed to the signal lines S1 and S2 in the drawing. The color filter CF is arranged at a position opposed to the pixel electrode PE, and a part of the color filter CF overlaps the light-shielding layer BM. The color filter CF includes a red color filter disposed in a pixel which exhibits red, a green color filter disposed in a pixel which exhibits green, a blue color filter disposed in a pixel which exhibits blue, and the like. The overcoat layer OC covers the color filter CF. The second alignment film AL2 covers the overcoat layer OC.

Note that the color filter CF may be arranged in the first substrate SUB1. The light-shielding layer BM may be arranged between the color filter CF and the overcoat layer OC, or between the overcoat layer OC and the second alignment film AL2. Alternatively, instead of arranging the light-shielding layer BM, two or more color filters of different colors may be stacked on one another to reduce the transmittance, so that the stacked color filters function as the light-shielding layer. Also, a pixel which exhibits white may be added, and a white color filter or an uncolored resin material may be disposed on the white pixel, or the overcoat layer OC may be disposed without arranging the color filters. Moreover, in a monochrome display device, a color filter is omitted.

The first substrate SUB1 and the second substrate SUB2 described above are arranged such that the first alignment film AL1 and the second alignment film AL2 are opposed to each other. Though not illustrated, a spacer is formed of a resin material, and is arranged between the first substrate SUB1 and the second substrate SUB2. The spacer is formed on one of the first substrate SUB1 and the second substrate SUB2, and is in contact with the other one of those substrates. A predetermined cell gap is thereby formed between the first alignment film AL1 and the second alignment film AL2. However, apart from the spacer which forms the cell gap, a sub-spacer which does not contact the other one of the substrates in the steady state in which no external stress is applied to the display panel may be included. The cell gap is, for example, 2 to 5 μm. The first substrate SUB1 and the second substrate SUB2 are adhered to each other by a sealant on the outside of an active area ACT in a state where the predetermined cell gap is created therebetween. A distance between the pixel electrode PE and the second substrate SUB2 in the third direction Z is substantially equal to the cell gap, and a distance between the common electrode CE and the second substrate SUB2 in the third direction Z is one-third or half the cell gap.

The liquid crystal layer LC is located between the first substrate SUB1 and the second substrate SUB2, and is held between the first alignment film AL1 and the second alignment film AL2. The liquid crystal layer LC includes liquid crystal molecules LM. The liquid crystal layer LC described above is composed of, for example, a positive liquid crystal material (i.e., a liquid crystal material with positive dielectric constant anisotropy).

In the present embodiment, the first alignment film AL1 and the second alignment film AL2 are vertical alignment films by which the liquid crystal molecules LM are aligned in a direction perpendicular to the substrate main surface (third direction Z). The substrate main surface mentioned above is a surface parallel to the X-Y plane. The liquid crystal molecules LM are initially aligned such that their long axes are aligned in a direction parallel to the third direction Z by an alignment restriction force of the first alignment film AL1 and the second alignment film AL2, as shown by a solid line in the drawing, in the off-state (OFF) in which no electric field is produced between the pixel electrode PE and the common electrode CE.

In the on-state (ON) in which an electric field is produced between the pixel electrode PE and the common electrode CE, as shown by a dotted line in the drawing, the liquid crystal molecules LM are aligned in a direction inclined with respect to the third direction Z such that their long axes are aligned along the electric field. In the example illustrated, since the common electrode CE is located closer to the second substrate SUB2 than the pixel electrode PE is, in the vicinity of the pixel electrode PE, an electric field is produced in such a way that it is slightly inclined with respect to the third direction Z. Meanwhile, in the vicinity of the common electrode CE, an electric field is produced in such a way that it is slightly inclined with respect to the substrate main surface. Accordingly, in the on-state, the liquid crystal molecules LM are aligned such that they are inclined in a direction from the pixel electrode PE, as the starting point, toward each of the main common electrodes CA1 and CA2. That is, as illustrated in the drawing, in a region between the pixel electrode PE and the main common electrode CA1, the liquid crystal molecules LM are all titled to the left in the drawing with respect to the third direction Z. Further, not only in the vicinity of the pixel electrode PE, but also in the vicinity of the main common electrode CA1, the liquid crystal molecules LM are aligned in the same direction. Also, in a region between the pixel electrode PE and the main common electrode CA2, the liquid crystal molecules LM are all titled to the right in the drawing with respect to the third direction Z. Further, not only in the vicinity of the pixel electrode PE, but also in the vicinity of the main common electrode CA2, the liquid crystal molecules LM are aligned in the same direction.

Further, as shown in FIG. 3, in the X-Y plane, the liquid crystal molecules LM in the off-state (OFF) are initially aligned in the third direction Z, as shown by a circle in the drawing. In the on-state (ON), the liquid crystal molecules LM are aligned in a direction shown by an arrow in the drawing. In the example illustrated, since the pixel electrode PE is formed in a cross shape, the liquid crystal molecules LM at the on-time are aligned in a plurality of directions, with boundaries at positions overlapping the pixel electrode PE, and domains are formed in the respective alignment directions. That is, a plurality of domains are formed in one pixel PX.

Returning to FIG. 4, the structure will be described again. With respect to the display panel PNL of the above structure, on the upper side of the second substrate SUB2, an optical element OD is disposed. The optical element OD includes, for example, a circular polarizer POL. The circular polarizer POL is constituted by combining a linear polarizer and a retardation plate. As the retardation plate, a quarter-wave plate is applied, and a half-wave plate may be combined in addition to the quarter-wave plate as necessary. Also, the optical element OD may include a scattering layer, an anti-reflective layer, and the like, in addition to the circular polarizer POL.

As will be described later, a sensor SS is mounted on the display device DSP of the present embodiment. In the illustrated cross-section, a detection electrode Rx which constitutes the sensor SS is arranged between the second insulating substrate 20 and the optical element OD. The detection electrode Rx is formed of a metal material such as aluminum (Al), titan (Ti), silver (Ag), molybdenum (Mo), tungsten (W), copper (Cu), or chrome (Cr), an alloy formed by combining these metal materials, a transparent oxide conductive material such as ITO or IZO, a conductive organic material, a dispersing element of a fine conductive substance, or the like. Although no detailed description will be given, the detection electrode Rx may have a single-layer structure or a multilayer structure in which a plurality of thin films are stacked. When the detection electrode Rx has a multilayer structure, a structure comprising an oxide conductive layer on a metal layer, for example, is applicable. When the detection electrode Rx is formed of an oxide conductive layer, the detection electrode Rx is formed in a strip shape, for example. When the detection electrode Rx is formed by a metal layer, the detection electrode Rx is formed of a thin metal wire, and is formed to be, for example, wavy, or in a lattice or mesh shape. The detection electrode Rx may be covered by a protective film where necessary. Details of the sensor SS will be described later.

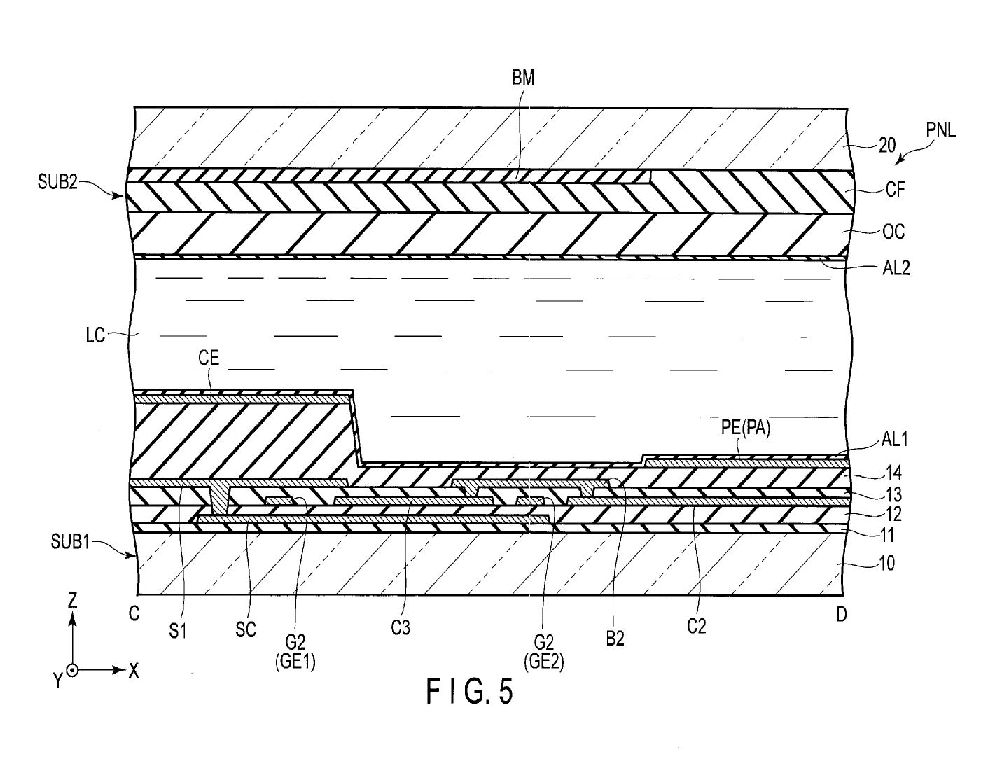

FIG. 5 is a cross-sectional view showing the structure of a part of the display panel PNL taken along line C-D of FIG. 3. Here, the optical element and the detection electrode are not illustrated.

In the first substrate SUB1, the gate electrodes GE1 and GE2 which are parts of the scanning line G2 are disposed in the same layer as the capacitance electrodes C2 and C3, are located on the second insulating film 12, and are covered by the third insulating film 13. The bridge portion B2 is disposed in the same layer as the signal line S1, is located on the third insulating film 13, and is covered by the fourth insulating film 14. The bridge portion B2 is disposed across the scanning line G2, and is in contact with each of the capacitance electrodes C2 and C3 through a contact hole which penetrates the third insulating film 13.

In such a structure, the second insulating film 12 corresponds to a first interlayer insulating film, and the third insulating film 13 corresponds to a second interlayer insulating film. The capacitance electrodes C2 and C3 which are electrically connected to each other by the bridge portion B2 are opposed to the semiconductor layer SC via the second insulating film 12, and constitute a capacitive element for forming the storage capacitance CS.

In the second substrate SUB2, the light-shielding layer BM is extended not only to a position opposed to the signal line S1, but also to a position opposed to the scanning line G2.

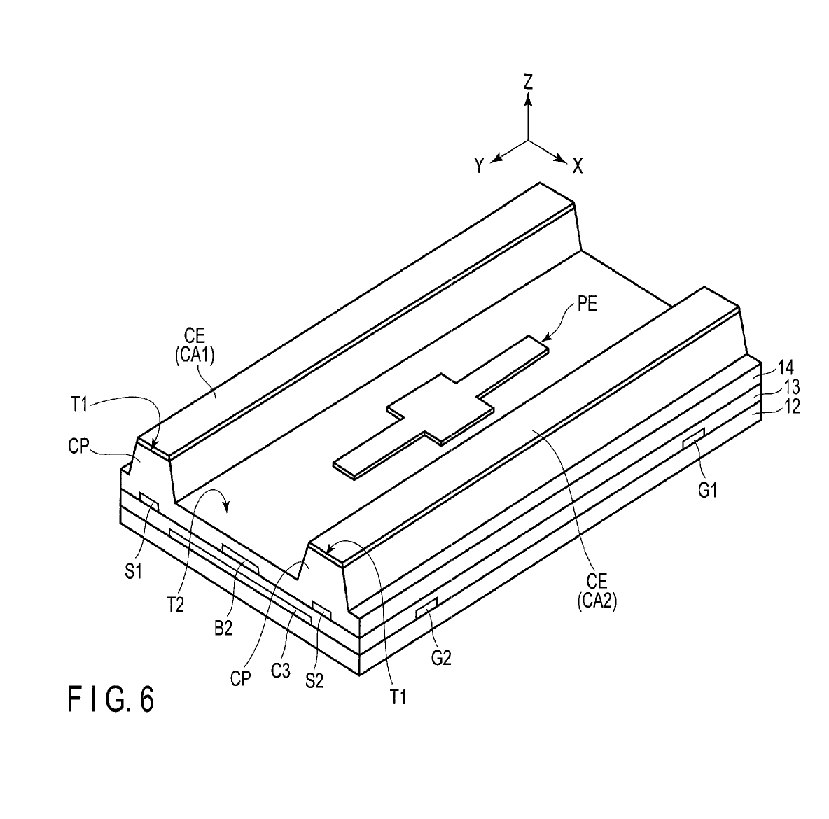

FIG. 6 is a perspective view showing a configuration example of the first substrate SUB1 illustrated in FIG. 3. Note that only the main portions of the first substrate SUB1 are taken out in the illustration.

The fourth insulating film 14 has the first upper surface T1 and the second upper surface T2, as described above. From another standpoint, the fourth insulating film 14 includes a projection (rib) CP projecting in the third direction Z with respect to the second upper surface T2, as illustrated in the drawing. The projection CP extends in the second direction Y over each of the signal lines S1 and S2. The common electrode CE is located on the projection CP, and the pixel electrode PE is located between the projections CP which are adjacent to each other in the first direction X.

The fourth insulating film 14 having such a shape can be formed by, for example, selecting a positive resist as a material of the fourth insulating film 14, and applying halftone exposure during the process of forming the fourth insulating film 14. That is, after forming the positive resist, an area corresponding to the projections CP is blocked from light, and an area other than the projections CP is exposed through a halftone mask. After that, the positive resist is developed in a developer. At this time, only the exposed surface layer of the positive resist is removed by the developer. Then, the positive resist is baked to form the fourth insulating film 14 including the projections CP.

According to the present embodiment described above, the first substrate SUB1 comprises the pixel electrode PE and the common electrode CE. Even with this structure, it is possible to drive the liquid crystal molecules by producing an electric field between the common electrode, which is located on the first upper surface of the organic insulating film, and the pixel electrode, which is located on the second upper surface of the organic insulating film, since a step is formed by the first upper surface and the second upper surface, and to realize a structure equivalent to a display mode using the longitudinal electric field. Also, by combining the positive liquid crystal layer LC and the vertical alignment film, a structure equivalent to a vertically aligned (VA) display mode can be realized. In particular, in a region between the pixel electrode PE and the common electrode CE, occurrence of a reverse tilt can be suppressed, and it becomes possible to make the alignment directions of the liquid crystal molecules uniform. Consequently, reduction of brightness (transmittance and reflectance) caused by disclination, or reduction in contrast ratio can be suppressed.

In addition, since the pixel electrode PE and the common electrode CE can be disposed in the same layer, as compared to a structure which requires an interlayer insulating film between the two electrodes, the manufacturing steps can be simplified, the manufacturing cost can be reduced, and the display panel can be made thin. Further, since a region which mainly contributes to display in one pixel is formed between the pixel electrode PE and the common electrode CE, the pixel electrode PE and the common electrode CE can be formed by a metal material. Accordingly, as compared to a case where the pixel electrode PE and the common electrode CE are both formed of ITO or IZO, the amount of indium (In) used can be reduced.

Also, a capacitance necessary for image display can be produced between the semiconductor layer SC and the capacitance electrode C. In particular, in a reflective display panel PNL, by extending the semiconductor layer SC located below the capacitance electrode which functions as the reflective layer, a capacitance that suits the need can be obtained easily.

In addition, in the second substrate SUB2, an electrode on the side opposed to the liquid crystal layer LC can be omitted. Accordingly, a display device DSP including the sensor SS mounted on the second substrate SUB2 can be realized. This point will be described in detail below.

Although the sensor SS mounted in the display device DSP of the present embodiment is, for example, a capacitive sensor, the type is not limited to this. Further, although a mutual-capacitive sensor SS which detects contact or approach of an object to be detected, based on a variation in the electrostatic capacitance between a pair of electrodes opposed to each other with a dielectric interposed therebetween, will be described below, the sensor SS is not limited to this example. For example, the sensor SS which can be mounted in the display device DSP of the present embodiment may be a self-capacitive sensor which detects an object based on a change in the electrostatic capacitance of the detection electrode Rx.

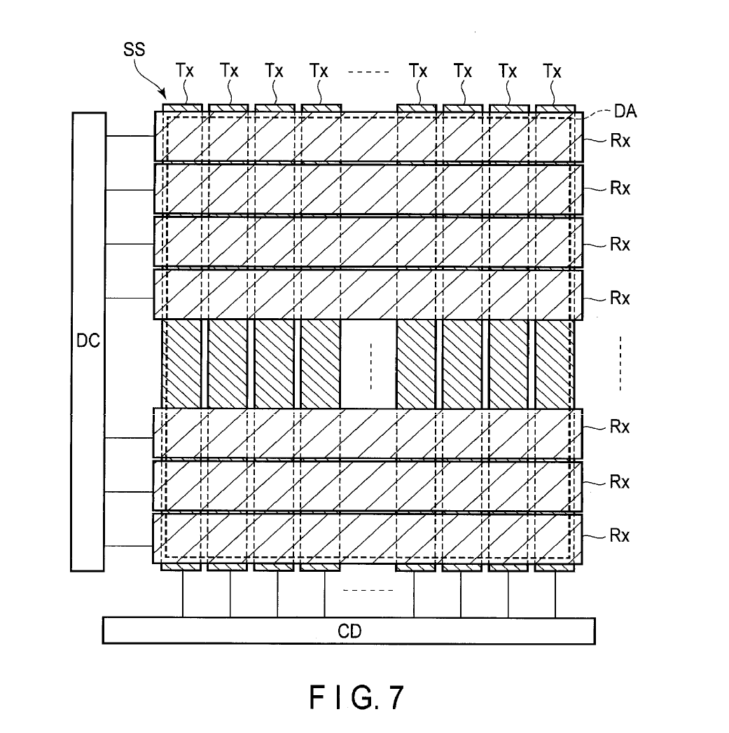

FIG. 7 is an illustration showing a configuration example of the sensor SS.

In the present embodiment, the sensor SS comprises a sensor driving electrode (a first electrode) Tx and the detection electrode (a second electrode) Rx. The sensor driving electrode Tx includes the common electrode CE and the capacitance electrode C shown in FIG. 3. The detection electrode Rx is located on an outer surface SBA of the second substrate SUB2, as shown in FIG. 4.

In the sensor SS mounted in the display device DSP described above, the sensor driving electrode Tx and the detection electrode Rx are located in the display area DA. In the example illustrated, each of the sensor driving electrode Tx and the detection electrode Rx has a strip shape. Although the sensor driving electrode Tx extends in the first direction X in the example shown in FIG. 3, it may be extended in the second direction Y. The detection electrode Rx extends in a direction crossing the sensor driving electrode Tx. For example, when the sensor driving electrodes Tx extend in the first direction X, and are arranged to be spaced apart from each other in the second direction Y, the detection electrodes Rx extend in the second direction Y, and are arranged to be spaced apart from each other in the first direction X. Meanwhile, when the detection electrodes Rx extend in the first direction X, and are arranged to be spaced apart from each other in the second direction Y, the sensor driving electrodes Tx extend in the second direction Y, and are arranged to be spaced apart from each other in the first direction X.

The sensor driving electrodes Tx are electrically connected to the common electrode drive circuit CD. The detection electrodes Rx are electrically connected to a detection circuit DC.

The common electrode drive circuit CD supplies a common drive signal to the sensor driving electrode Tx including the common electrode CE and the capacitance electrode C at a display drive time in which an image is displayed. Thereby, the sensor driving electrode Tx produces an electric field between the sensor driving electrode Tx and the pixel electrode PE, and drives the liquid crystal layer LC.

Also, the common electrode drive circuit CD supplies a sensor drive signal to each of the sensor driving electrodes Tx at a sensing drive time in which sensing is performed to detect contact or approach of the object to be detected. Thereby, the sensor driving electrode Tx produces a capacitance between the sensor driving electrode Tx and the detection electrode Rx. Each of the detection electrodes Rx outputs a sensor signal necessary for sensing (that is, a signal based on a change in the interelectrode capacitance between the sensor driving electrode Tx and the detection electrode Rx) in accordance with supply of the sensor drive signals to the sensor driving electrodes Tx. The detection circuit DC reads the sensor signal from the detection electrode Rx, and detects the presence or absence of contact or approach of the object to be detected and also position coordinates, etc., of the object to be detected.

Note that the number, size, and shape of the sensor driving electrode Tx and the detection electrode Rx are not particularly limited, and can be changed variously. For example, the detection electrodes Rx may be formed in an island shape and arrayed in a matrix in the first direction X and the second direction Y.

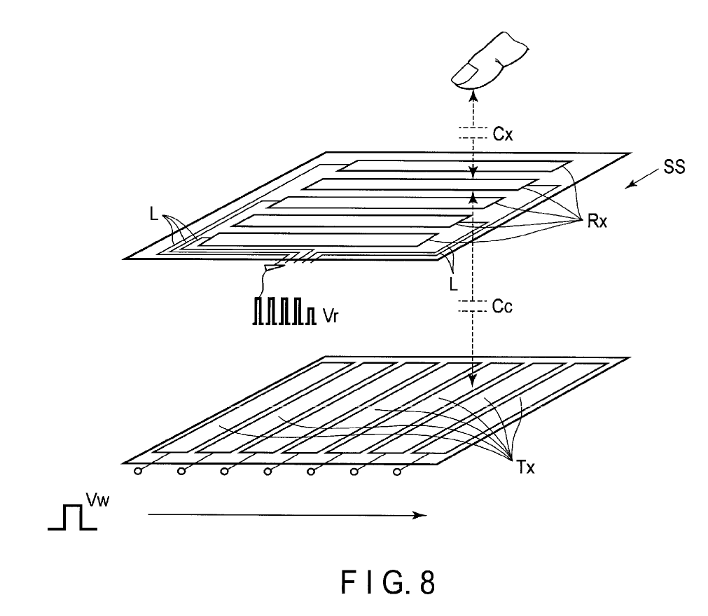

Next, the principle of one example of a sensing method for detecting contact or approach of an object to be detected in the above sensor SS will be described referring to FIG. 8.

A capacitance Cc exists between the sensor driving electrode Tx and the detection electrode Rx. A pulse-like write signal (sensor drive signal) Vw is supplied to the sensor driving electrodes Tx, sequentially, in a predetermined cycle. In this example, it is assumed that the user's finger, which is the object to be detected, is present closely to a position where a specific detection electrode Rx and a specific sensor driving electrode Tx cross each other. A capacitance Cx is produced by the object to be detected close to the detection electrode Rx. When the write signal Vw is supplied to the sensor driving electrode Tx, from the specific detection electrode Rx, a pulse-like read signal (sensor signal) Vr of a level lower than levels of pulses obtained from the other detection electrodes is obtained.

The detection circuit DC shown in FIG. 7 can detect two-dimensional position information on the object to be detected in the X-Y plane of the sensor SS, based on the timing when the write signal Vw is supplied to the sensor driving electrode Tx and the read signals Vr from the respective detection electrodes Rx. In addition, the capacitance Cx is different in cases where the object to be detected is close to the detection electrode Rx and the object to be detected is far from the detection electrode Rx. Accordingly, the level of the read signal Vr is also different in cases where the object to be detected is close to the detection electrode Rx and the object to be detected is far from the same. Therefore, in the detection circuit DC, based on the level of the read signal Vr, the proximity of the object to be detected to the sensor SS can also be detected.

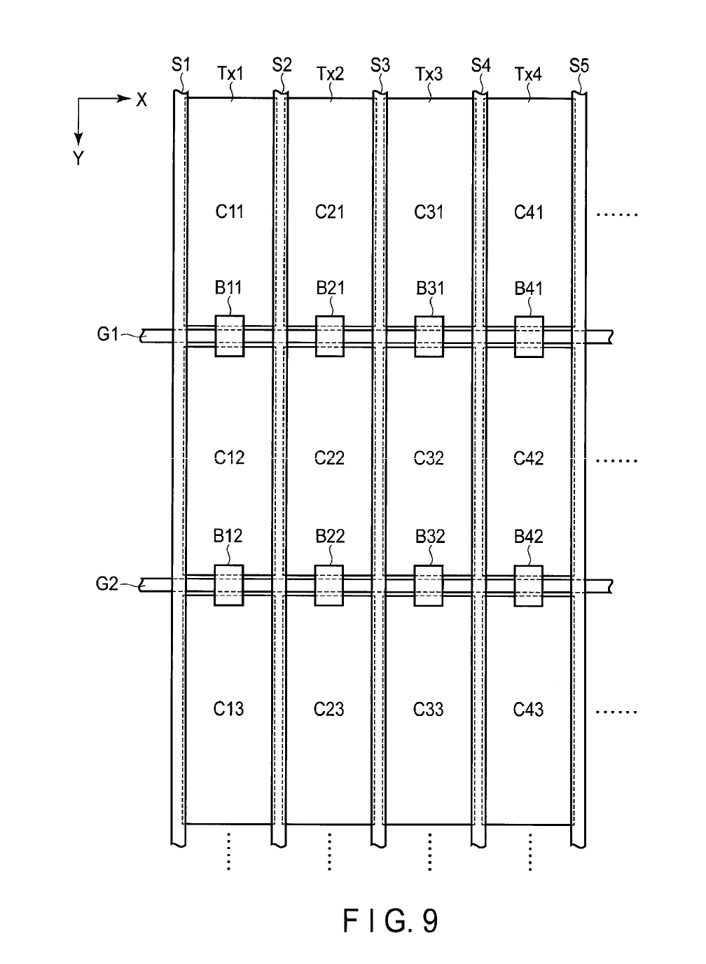

FIG. 9 is a plan view showing a configuration example of the capacitance electrode C included in the sensor driving electrode Tx shown in FIG. 7. Note that illustration of the common electrode which overlaps the signal lines is omitted.

The example illustrated in FIG. 9 corresponds to a case where the sensor driving electrodes Tx are each arranged between the signal lines adjacent to each other in the first direction X. That is, capacitance electrodes C11 to C13 arranged in the second direction Y are located between the signal lines S1 and S2, are electrically connected to each other by bridge portions B11 and B12, and constitute a sensor driving electrode Tx1. Similarly, capacitance electrodes C21 to C23 which constitute a sensor driving electrode Tx2 are located between the signal lines S2 and S3, and are electrically connected to each other by bridge portions B21 and B22. Capacitance electrodes C31 to C33 which constitute a sensor driving electrode Tx3 are located between the signal lines S3 and S4, and are electrically connected to each other by bridge portions B31 and B32. Capacitance electrodes C41 to C43 which constitute a sensor driving electrode Tx4 are located between the signal lines S4 and S5, and are electrically connected to each other by bridge portions B41 and B42. Each of these sensor driving electrodes Tx1 to Tx4 is connected to the common electrode drive circuit CD in the non-display area NDA.

According to this configuration example, in detecting the position coordinates of an object, a position coordinate in the first direction X can be detected with high accuracy. Also, according to need, by electrically bundling the sensor driving electrodes Tx for drive of the sensor driving electrodes Tx, the detection accuracy in the first direction X can be varied.

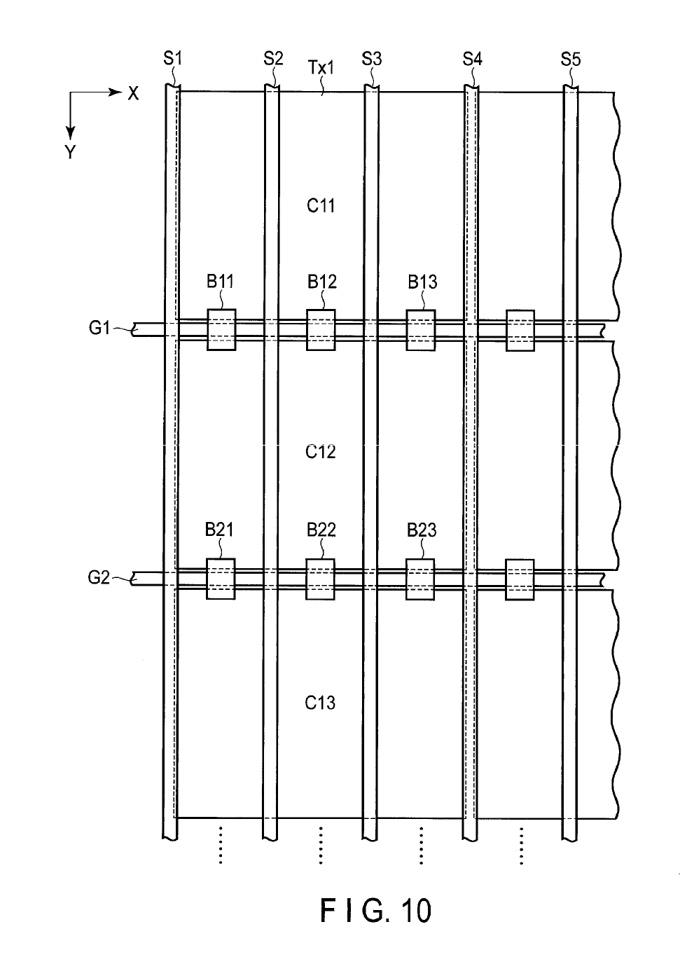

FIG. 10 is a plan view showing another configuration example of the capacitance electrode C included in the sensor driving electrode Tx shown in FIG. 7.

The example illustrated in FIG. 10 is different from the example illustrated in FIG. 9 in that a single sensor driving electrode Tx is disposed to extend over a plurality of signal lines arranged in the first direction X. That is, each of the capacitance electrodes C11 to C13 is located between the signal lines S1 and S4, and crosses the signal lines S2 and S3. In other words, each of the capacitance electrodes C11 to C13 is disposed across three pixels arranged in the first direction X. The capacitance electrodes C11 and C12 are electrically connected to each other by bridge portions B11 to B13. The capacitance electrodes C12 and C13 are electrically connected to each other by bridge portions B21 to B23. As can be seen, the capacitance electrodes C11 to C13 are electrically connected to each other and constitute the sensor driving electrode Tx1.

According to this configuration example, since each of the sensor driving electrodes Tx is formed to be wide in the first direction X, a large capacitance Cc can be obtained between the sensor driving electrode Tx and the detection electrode Rx, thereby improving sensitivity of the sensing.

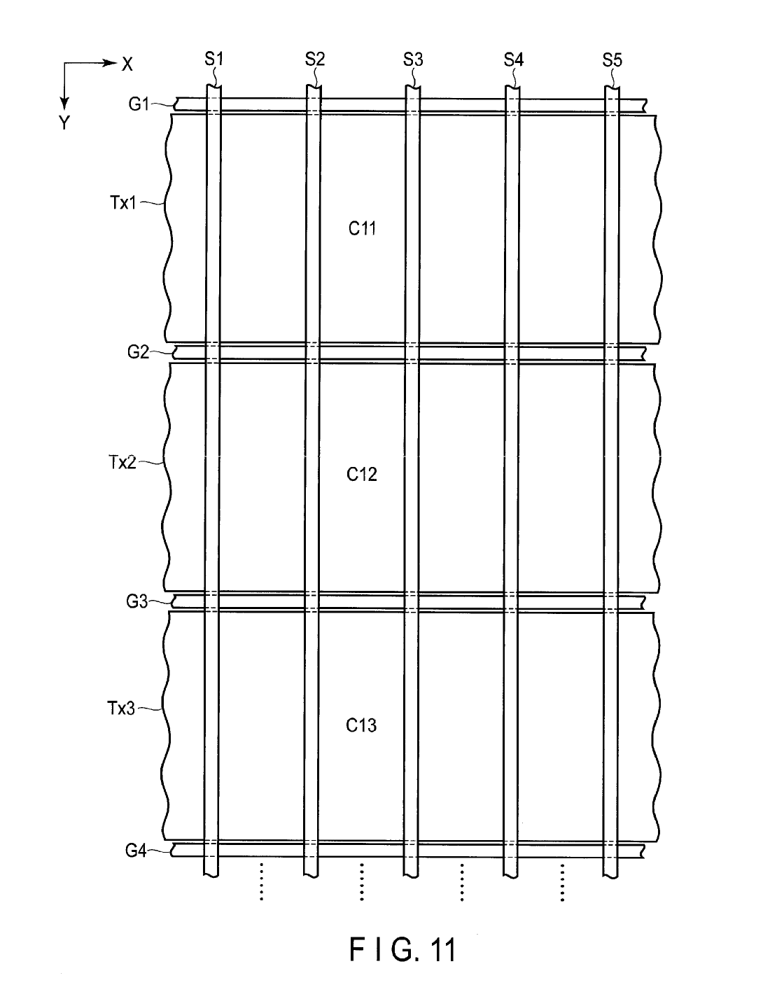

FIG. 11 is a plan view showing another configuration example of the capacitance electrode C included in the sensor driving electrode Tx shown in FIG. 7.

The example illustrated in FIG. 11 is different from the example illustrated in FIG. 9 in that the sensor driving electrodes Tx extend in the first direction X. That is, the capacitance electrode C11 is located between the scanning lines G1 and G2, extends in the first direction X, and constitutes the sensor driving electrode Tx1. Similarly, the capacitance electrode C12 is located between the scanning lines G2 and G3, extends in the first direction X, and constitutes the sensor driving electrode Tx2. The capacitance electrode C13 is located between the scanning lines G3 and G4, extends in the first direction X, and constitutes the sensor driving electrode Tx3. Each of the capacitance electrodes C11 to C13 crosses the signal lines S1 to S5.

In this configuration example, although electrical connection by a bridge portion becomes unnecessary, the capacitance electrodes arranged in the second direction Y may be electrically connected to each other by a bridge portion if needed.

Next, another configuration example of the present embodiment will be described. Note that the same constituent elements as those of the above-explained configuration examples will be denoted by the same reference numbers, and detailed descriptions of them will be omitted.

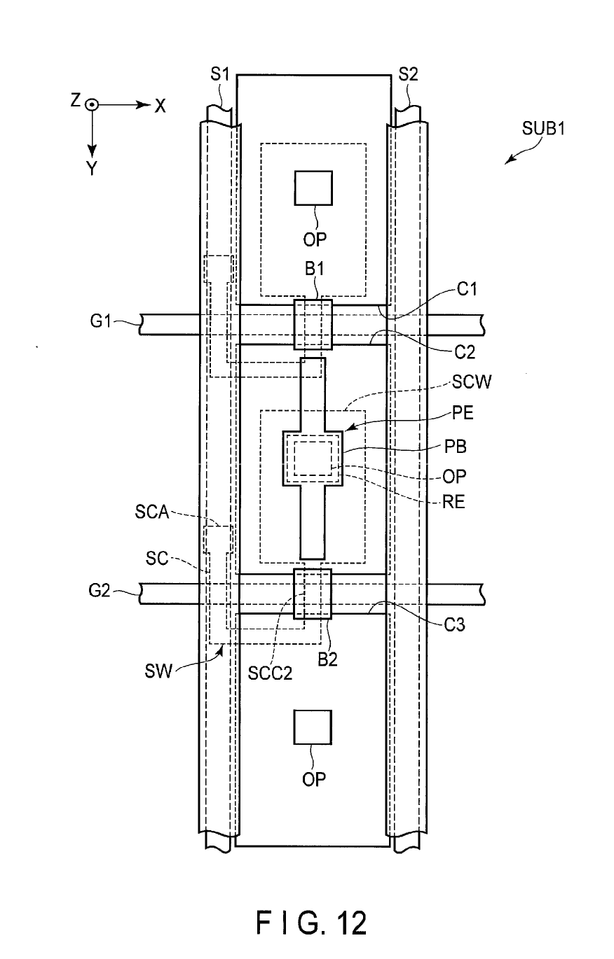

FIG. 12 is a plan view showing another configuration example of the pixel PX when the first substrate SUB1 shown in FIG. 1 is viewed from the second substrate side.

The configuration example shown in FIG. 12 is different from the configuration example shown in FIG. 3 in that the semiconductor layer SC includes an extension portion SCW in a region opposed to the capacitance electrode C2. That is, the semiconductor layer SC includes a substantially uniform width in a region between the end portion SCA and the channel region SCC2, and includes the extension portion SCW which is more extended in the first direction X than the channel region SCC2 in a region between the scanning lines G1 and G2. The extension portion SCW overlaps the relay electrode RE via the opening OP. In the example illustrated, the extension portion SCW is formed to be wider than the pixel electrode PE in planar view.

If this configuration example is adopted, as compared to the configuration example illustrated in FIG. 3, it becomes possible to retain a large capacitance between the semiconductor layer SC and the capacitance electrode C2 without reducing an area which contributes to display in the reflective display panel PNL in which the capacitance electrode C2 is applied as the reflective layer.

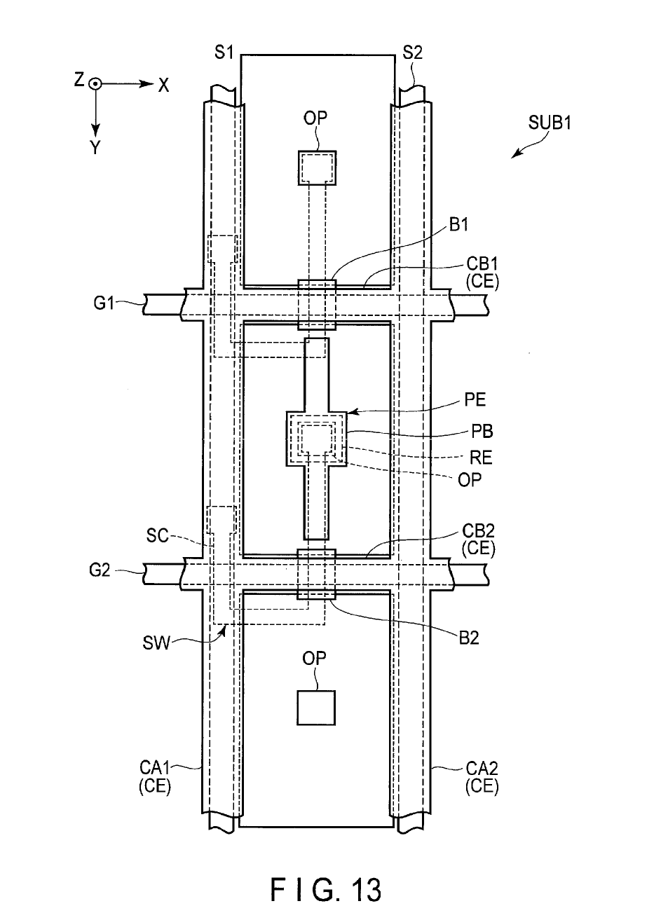

FIG. 13 is a plan view showing yet another configuration example of the pixel PX when the first substrate SUB1 shown in FIG. 1 is viewed from the second substrate side.

The configuration example shown in FIG. 13 is different from the configuration example shown in FIG. 3 in that the common electrode CE is formed in a lattice shape. That is, the common electrode CE includes sub-common electrodes CB1 and CB2, in addition to the main common electrodes CA1 and CA2. Each of the sub-common electrodes CB1 and CB2 extends linearly in the first direction X, and is formed in a strip shape having a substantially uniform width in the second direction Y. Each of the sub-common electrodes CB1 and CB2 is connected to the main common electrodes CA1 and CA2. In the example illustrated, the sub-common electrode CB1 overlaps the scanning line G1, and crosses the bridge portion B1. Also, the sub-common electrode CB2 overlaps the scanning line G2, and crosses the bridge portion B2. The pixel electrode PE is located at an inner side surrounded by the common electrode CE. The main common electrodes CA1 and CA2, and the sub-common electrodes CB1 and CB2 are separated from the pixel electrode PE.

According to such a configuration example, the sub-common electrodes CB1 and CB2 can block an undesired electric field from the scanning lines G1 and G2, and suppress alignment failure of liquid crystal molecules near the scanning lines G1 and G2. In addition, by an electric field produced between the pixel electrode PE and the common electrode CE surrounding the periphery of the pixel electrode PE, the liquid crystal molecules can be aligned radially with the pixel electrode PE being the center in the X-Y plane. Therefore, a viewing angle can be compensated optically, thereby realizing a wide viewing angle.

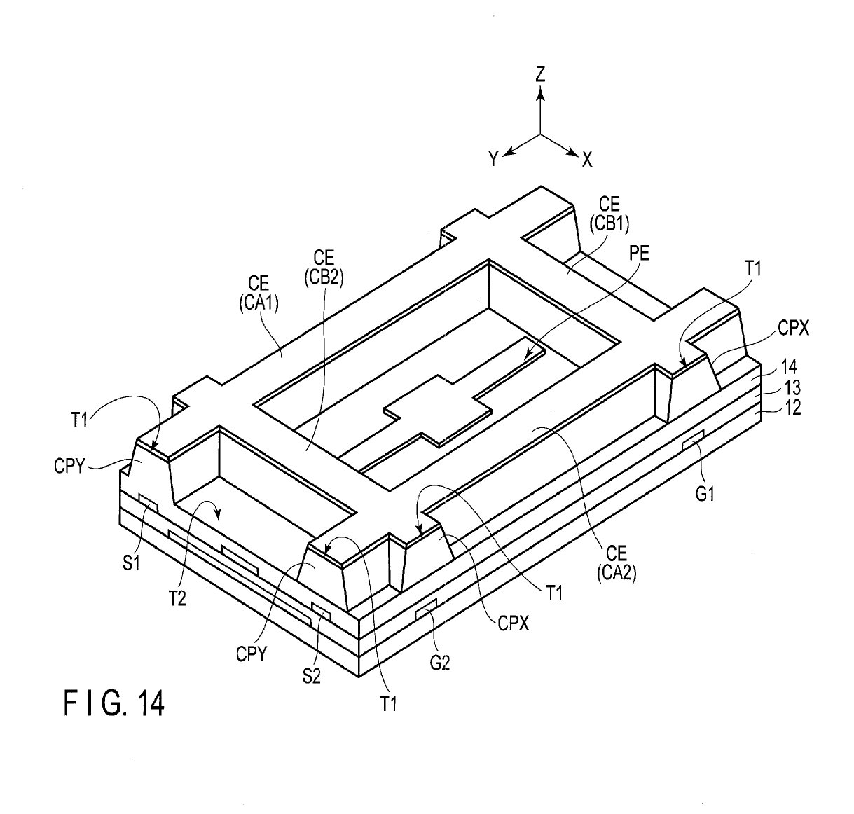

FIG. 14 is a perspective view showing a configuration example of the first substrate SUB1 illustrated in FIG. 3.

The configuration example shown in FIG. 14 is different from the configuration example shown in FIG. 6 in that the fourth insulating film 14 includes projections forming a lattice-like pattern. That is, the fourth insulating film 14 includes a projection CPX extending in the first direction X in addition to a projection CPY extending in the second direction Y. The projections CPY are located on the signal lines S1 and S2, respectively. The projections CPX are located on the scanning lines G1 and G2, and are connected to the projections CPY, respectively. The pixel electrode PE is located at an inner side surrounded by the projections CPX and the projections CPY. In the example illustrated, the common electrode CE includes the main common electrodes CA1 and CA2 located on upper surfaces T1 of the projections CPY, and the sub-common electrodes CB1 and CB2 located on upper surfaces T1 of the projections CPX.

The configuration example illustrated is suitable when the common electrode CE having the shape shown in FIG. 13 is applied.

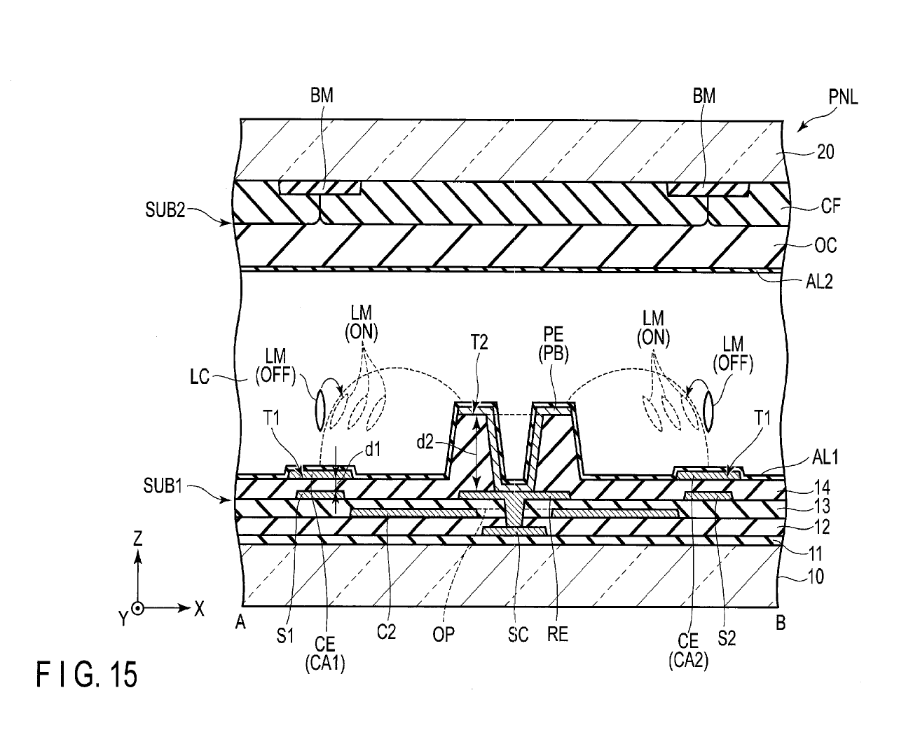

FIG. 15 is a cross-sectional view showing another configuration example of the display panel PNL taken along line A-B of FIG. 3.

The configuration example shown in FIG. 15 is different from the configuration example shown in FIG. 4 in that the pixel electrode PE is closer to the second substrate SUB2 than the common electrode CE is. In the fourth insulating film 14 which serves as a common base for the pixel electrode PE and the common electrode CE, the second upper surface T2 is located closer to the second substrate SUB2 than the first upper surface T1 is. The first upper surface T1 is located directly above the signal lines S1 and S2, and the capacitance electrode C2. The common electrodes CE (the main common electrodes CA1 and CA2) are located on the first upper surface T1. Further, in the first upper surface T1, a region which does not overlap the common electrode CE is covered with the first alignment film AL1. The second upper surface T2 is located directly above the relay electrode RE. The pixel electrode PE is located on the second upper surface T2.

As regards the film thickness of the fourth insulating film 14, the first film thickness d1 between the signal line and the common electrode, more specifically, each of the signal lines S1 and S2 and the common electrodes CE (the main common electrodes CA1 and CA2) is smaller than the second film thickness d2 between the relay electrode RE and the pixel electrode PE.

As in the configuration example described above, when the first alignment film AL1 and the second alignment film AL2 are vertical alignment films, and the liquid crystal layer LC is formed of a positive liquid crystal material, the liquid crystal molecules LM are driven as stated below. That is, in the off-state (OFF), the liquid crystal molecules LM are initially aligned such that their long axes are aligned in the direction parallel to the third direction Z, as shown by a solid line in the drawing. In the on-state (ON), the liquid crystal molecules LM are aligned in the direction inclined with respect to the third direction Z such that their long axes are aligned along the electric field, as shown by a dotted line in the drawing. In the example illustrated, since the pixel electrode PE is located closer to the second substrate SUB2 than the common electrode CE is, in the vicinity of the common electrode CE, an electric field is produced in such a way that it is slightly inclined with respect to the third direction Z. Meanwhile, in the vicinity of the pixel electrode PE, an electric field is produced in such a way that it is slightly inclined with respect to the substrate main surface. Accordingly, in the on-state, the liquid crystal molecules LM are aligned such that they are inclined in a direction from each of the main common electrodes CA1 and CA2 toward the pixel electrode PE. That is, as illustrated in the drawing, in a region between the pixel electrode PE and the main common electrode CA1, the liquid crystal molecules LM are all titled to the right in the drawing with respect to the third direction Z. Further, not only in the vicinity of the main common electrode CA1 but also in the vicinity of the pixel electrode PE, the liquid crystal molecules LM are aligned in the same direction. Also, in a region between the pixel electrode PE and the main common electrode CA2, the liquid crystal molecules LM are all titled to the left in the drawing with respect to the third direction Z. Further, not only in the vicinity of the main common electrode CA2 but also in the vicinity of the pixel electrode PE, the liquid crystal molecules LM are aligned in the same direction. Thereby, likewise the above configuration example, a plurality of domains can be formed in one pixel PX. Accordingly, also in this configuration example, the same advantages as those of the above configuration example can be obtained.

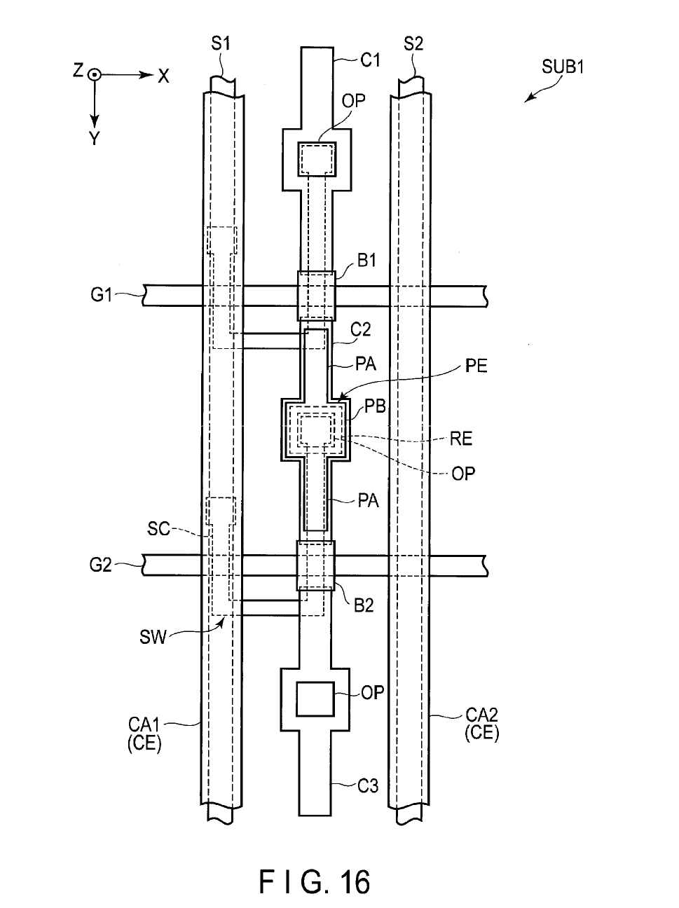

FIG. 16 is a plan view showing yet another configuration example of the pixel PX when the first substrate SUB1 shown in FIG. 1 is viewed from the second substrate side.

The configuration example shown in FIG. 16 is different from the configuration example shown in FIG. 3 in that a width of each of the capacitance electrodes C1 to C3 is reduced, and a transmissive region is formed between the pixel electrode PE and the common electrode CE. That is, each of the capacitance electrodes C1 to C3 is formed in substantially the same shape as the pixel electrode PE, and the width of each capacitance electrode along the first direction X is equal to the width of the pixel electrode PE. When a positional relationship between the pixel electrode PE and the capacitance electrode C2 in the drawing is noted, in planar view, a substantially entire body of the capacitance electrode C2 overlaps the pixel electrode PE. Accordingly, in a region between the pixel electrode PE and the main common electrode CA1, and a region between the pixel electrode PE and the main common electrode CA2, a light-shielding electrode barely exists, and thus, transmissive regions are formed. Also, the capacitance electrodes C1 to C3 extend in the second direction Y near the scanning lines G1 and G2, and are electrically connected to each other via the bridge portions B1 and B2.

According to the configuration example described above, not only can the advantages which are the same as those of the above configuration example be obtained, but a transmissive display panel can be provided.

Note that in the configuration example illustrated in FIG. 16, the common electrode CE may be located closer to the second substrate SUB2 than the pixel electrode PE is, as shown in FIG. 4, or the pixel electrode PE may be located closer to the second substrate SUB2 than the common electrode CE is, as shown in FIG. 15. Also, the configuration examples described above may be combined as appropriate.

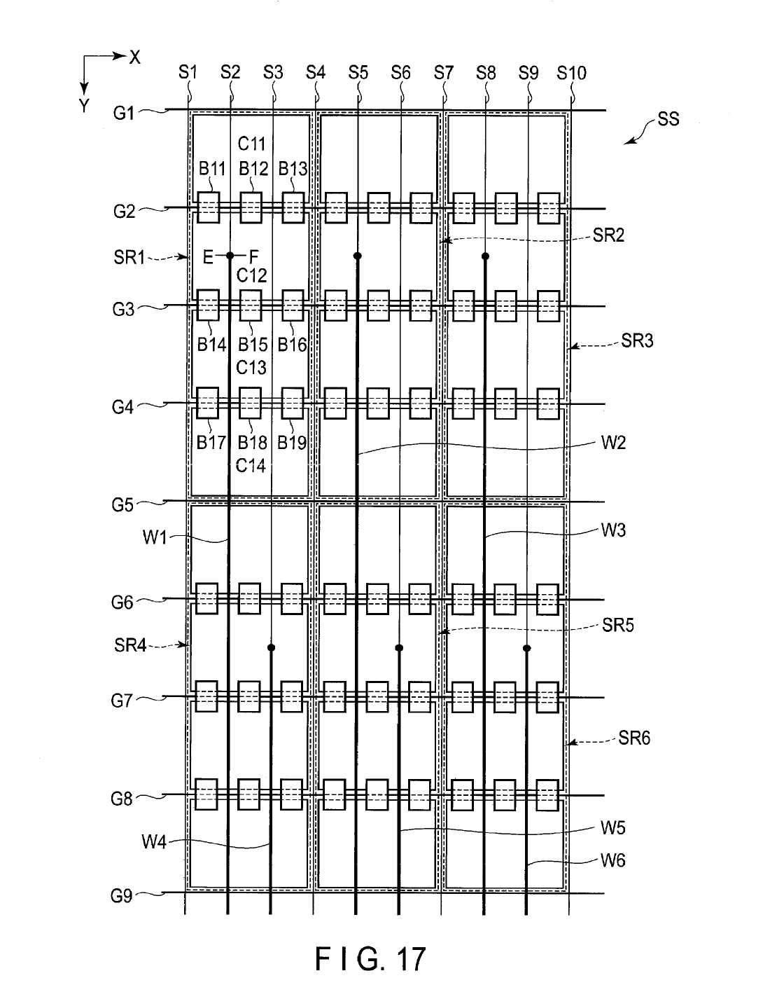

FIG. 17 is an illustration showing another configuration example of the sensor SS. The sensor SS illustrated comprises sensor electrodes SR1 to SR6 arrayed in a matrix in the first direction X and the second direction Y. Although six sensor electrodes are illustrated in the drawing, the number of sensor electrodes provided in the sensor SS is not limited to the example illustrated.

The illustrated sensor SS is constituted of capacitance electrodes provided in the display area DA of the first substrate SUB1. S1 to S10 in the drawing denote the signal lines, and G1 to G9 denote the scanning lines.

The sensor electrodes SR1 to SR3 are arranged in the first direction X, the sensor electrodes SR4 to SR6 are arranged in the first direction X, and the sensor electrodes SR1 and SR4, SR2 and SR5, and SR3 and SR6 are arranged in the second direction Y. The sensor electrodes SR1 to SR6 all have the same structure, and here, the structure of the sensor electrode SR1 will be specifically described as an example. In the example depicted, the sensor electrode SR1 comprises capacitance electrodes C11 to C14, and bridge portions B11 to B19. The capacitance electrode C11 between the scanning lines G1 and G2 is located between the signal lines S1 and S4, and crosses the signal lines S2 and S3. That is, the capacitance electrode C11 is disposed across three pixels arranged in the first direction X. Similarly, each of the capacitance electrodes C12 to C14 crosses the signal lines S2 and S3. The capacitance electrodes C11 and C12 are electrically connected to each other by the bridge portions B11 to B13. Similarly, the capacitance electrodes C12 and 013 are electrically connected to each other by the bridge portions B14 to B16, and the capacitance electrodes C13 and C14 are electrically connected to each other by the bridge portions B17 to B19. Thereby, the capacitance electrodes C11 to C14 are electrically connected to each other and constitute a single sensor electrode SR1.

The sensor electrodes SR1 to SR6 are electrically connected to lead-out lines W1 to W6, respectively. Each of the lead-out lines W1 to W6 extends in the second direction Y. In the example illustrated, the lead-out lines W1 to W3 overlap the signal lines S2, S5, and S8, respectively, and the lead-out lines W4 to W6 overlap the signal lines S3, S6, and S9, respectively. A black dot in the drawing indicates a contact portion where the sensor electrode and the lead-out line are connected. The lead-out lines W1 to W6 are drawn to a non-display area, and are connected to a sensor circuit not illustrated.

The sensor circuit detects the presence or absence of contact or approach of an object to be detected, and also position coordinates, etc., of the object to be detected by writing a sensor drive signal to each of the sensor electrodes, and reading a detection signal showing a change in the electrostatic capacitance produced in each of the sensor electrodes. In the sensor SS having such a structure, it becomes unnecessary to provide detection electrodes Rx at the second substrate SUB2 as has been described above.

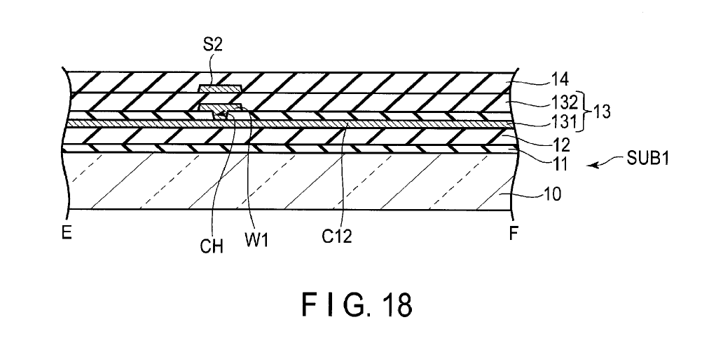

FIG. 18 is a cross-sectional view of a contact portion taken along line E-F of FIG. 17. Although FIG. 18 illustrates a cross-section of a part of the first substrate SUB1, illustration of the structure closer to the liquid crystal layer side with respect to the fourth insulating film 14 is omitted. In the example illustrated, the first substrate SUB1 includes a first layer 131 and a second layer 132 as the third insulating film 13. The capacitance electrode C12 is located on the second insulating film 12 and is covered with the first layer 131. The lead-out line W1 is located on the first layer 131, and is covered with the second layer 132. Also, the lead-out line W1 is in contact with the capacitance electrode C12 through a contact hole CH which penetrates the first layer 131. The signal line S2 is located on the second layer 132, and is covered with the fourth insulating film 14. The signal line S2 is located directly above the lead-out line W1. The contact hole CH is formed at a position different from the location of a contact hole for connecting the semiconductor layer and the signal line.

In the case of the above structure, the bridge portion shown in FIG. 17 can be formed in the same layer as the lead-out line, in which case, the bridge portion is disposed on the first layer 131. Also, in another structure, the bridge portion can be formed in the same layer as the signal line and the relay electrode, in which case, the bridge portion is disposed on the second layer 132. When the bridge portion is disposed on the second layer 132, the lead-out line may be drawn in the first direction X so as to overlap the scanning line.

As described above, a liquid crystal display device, a wiring substrate, and a sensor-equipped display device capable of suppressing deterioration in the display quality can be provided according to the present embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first substrate comprising an insulating substrate, an organic insulating film including a first upper surface and a second upper surface, a step being created by a height difference between the first upper surface and the second upper surface, a common electrode located on the first upper surface, a pixel electrode located on the second upper surface, and a first alignment film which covers the common electrode and the pixel electrode;
a second substrate comprising a second alignment film opposed to the first alignment film; and
a liquid crystal layer held between the first alignment film and the second alignment film.

2. The liquid crystal display device of claim 1, wherein:
the first substrate further comprises a signal line located between the insulating substrate and the common electrode, and a relay electrode located between the insulating substrate and the pixel electrode; and
the organic insulating film covers the signal line and the relay electrode, has a first film thickness between the signal line and the common electrode, and a second film thickness different from the first film thickness between the relay electrode and the pixel electrode.

3. The liquid crystal display device of claim 1, wherein the common electrode is closer to the second substrate than the pixel electrode is.

4. The liquid crystal display device of claim 1, wherein the pixel electrode is closer to the second substrate than the common electrode is.

5. The liquid crystal display device of claim 1, wherein the pixel electrode and the common electrode are formed of a same metal material.

6. The liquid crystal display device of claim 1, wherein:
the first substrate further comprises a semiconductor layer, a first interlayer insulating film which covers the semiconductor layer, a scanning line and a capacitance electrode located on the first interlayer insulating film, and a second interlayer insulating film which covers the scanning line and the capacitance electrode; and
the capacitance electrode has a same potential as the common electrode, and is opposed to the semiconductor layer.

7. The liquid crystal display device of claim 6, wherein the first substrate further comprises a bridge portion which is located on the second insulating film, is electrically connected to the capacitance electrode, and crosses the scanning line.

8. The liquid crystal display device of claim 6, wherein the capacitance electrode extends over a region between the pixel electrode and the common electrode in planar view.

9. The liquid crystal display device of claim 1, wherein the first substrate further comprises a first signal line and a second signal line arranged in a first direction, a first scanning line and a second scanning line arranged in a second direction intersecting the first direction, and a first capacitance electrode surrounded by the first and second signal lines and the first and second scanning lines.

10. The liquid crystal display device of claim 9, wherein:
the first substrate further comprises a second capacitance electrode located between the first and second signal lines, and a bridge portion crossing the first scanning line;
the first scanning line is located between the first and second capacitance electrodes; and
the bridge portion electrically connects the first and second capacitance electrodes to each other.

11. The liquid crystal display device of claim 1, wherein the first substrate further comprises a first signal line and a second signal line arranged in a first direction, a first scanning line and a second scanning line arranged in a second direction intersecting the first direction, and a first capacitance electrode which crosses the first and second signal lines, and is located between the first and second scanning lines.

12. The liquid crystal display device of claim 11, wherein:
the first substrate further comprises a second capacitance electrode crossing the first and second signal lines, and a bridge portion crossing the first scanning line;
the first scanning line is located between the first and second capacitance electrodes; and
the bridge portion electrically connects the first and second capacitance electrodes to each other.

13. The liquid crystal display device of claim 1, wherein:
the first substrate further comprises a capacitance electrode which is formed in substantially a same shape as the pixel electrode; and
an entire body of the pixel electrode overlaps the capacitance electrode in planar view.

14. The liquid crystal display device of claim 1, wherein the first substrate further comprises a reflective layer between the insulating substrate and the organic insulating film.

15. The liquid crystal display device of claim 1, wherein each of the first alignment film, and the second alignment film is vertical alignment film and a type of the liquid crystal layer is positive.

16. The liquid crystal display device of claim 1, wherein the common electrode comprises two main common electrodes each formed in a strip shape, and the pixel electrode is located between the two main common electrodes.

17. The liquid crystal display device of claim 1, wherein the common electrode is formed in a lattice shape, and the pixel electrode is located at an inner side surrounded by the common electrode.

18. A wiring substrate comprising:
a first interlayer insulating film;
a scanning line, a first capacitance electrode, and a second capacitance electrode, which are located on the first interlayer insulating film and are separated from each other;
a second interlayer insulating film which covers the scanning line, the first capacitance electrode, and the second capacitance electrode;
a bridge portion which is located on the second interlayer insulating film, electrically connects the first capacitance electrode and the second capacitance electrode to each other, and crosses the scanning line; and
a signal line which is located on the second interlayer insulating film, is separated from the bridge portion, and crosses the scanning line.

19. The wiring substrate of claim 18, further comprising a switching element electrically connected to the scanning line and the signal line, an organic insulating film including a first upper surface and a second upper surface, a step being created by a height difference between the first upper surface and the second upper surface, a common electrode located on the first upper surface, a pixel electrode located on the second upper surface and electrically connected to the switching element.

20. A sensor-equipped display device comprising:
a first substrate comprising a sensor driving electrode;
a second substrate comprising a detection electrode; and
a liquid crystal layer held between the first substrate and the second substrate,
the first substrate comprising:
a first interlayer insulating film;
a scanning line, a first capacitance electrode, and a second capacitance electrode, which are located on the first interlayer insulating film and are separated from each other;
a second interlayer insulating film which covers the scanning line, the first capacitance electrode, and the second capacitance electrode; and
a bridge portion which is located on the second interlayer insulating film, electrically connects the first capacitance electrode and the second capacitance electrode to each other, and crosses the scanning line,
the sensor driving electrode comprising the first capacitance electrode, the second capacitance electrode, and the bridge portion.

21. The sensor-equipped display device of claim 20, wherein the first substrate further comprises an organic insulating film including a first upper surface and a second upper surface, a step being created by a height difference between the first upper surface and the second upper surface, a common electrode located on the first upper surface, a pixel electrode located on the second upper surface, and a first alignment film which covers the common electrode and the pixel electrode.
